(19) United States
(12) Patent Application Publication
(10) Pub. No.: US 2012/0129125 A1
(43) Pub. Date: May 24, 2012

(54) DENTAL MATRIX BAND

(76) Inventor: Essam N. IBRAHIM, Glen Burnie, MD (US)

(21) Appl. No.: 12/954,266

(22) Filed: Nov. 24, 2010

(51) Int. Cl. A61C 5/04

(52) U.S. Cl. 433/39; 433/226

(57) ABSTRACT

A dental matrix band device may be applied in a single step without the need for additional instruments for its application. The matrix band device may include a conventional matrix band, such as a Tofflemier™ band and a wire attached to the band. The band may be used to separate adjacent teeth, while the wire keeps the band in place until the procedure is completed. At the completion of the procedure, the band and wire are easily removed from the patient.

### BACKGROUND OF THE INVENTION

The present invention relates to dental tools and, more particularly, to a dental matrix band that may be quickly and easily applied about a tooth.

Matrix bands are extensively used by dentists to fill cavitations which open through any of the vertical surfaces of a tooth. Such bands are applied circumferentially about the crown of a tooth with the lateral dimension or width of the band extending from the cervical toward the occlusal surfaces of the tooth. Once in place, the band is placed under hoop stressing by a retaining appliance to provide a dam-like mold against which a filling material may be compacted. These conventional devices have multiple steps to place the matrix band.

As can be seen, there is a need for a dental matrix band that may be applied in a few or a single step without the need for additional instruments.

### SUMMARY OF THE INVENTION

In one aspect of the present invention, a matrix band device comprises a matrix band; a wire adapted to attach to the matrix band, the wire having two legs connected together and bent to form angled portions, wherein the angled portions are attached to the matrix band.

In another aspect of the present invention, a method for isolating a tooth for a dental restoration comprises resiliently deforming angled ends of a wire, the angled ends being attached to a matrix band; sliding the matrix band about an occlusal surface of the tooth while the angled ends of the wire are positioned at lingual and buccal sides of the tooth; and retaining the matrix band in place by allowing a resilient force of the angled ends of the wire to press against the lingual and buccal sides of the tooth.

These and other features, aspects and advantages of the present invention will become better understood with reference to the following drawings, description and claims.

### BRIEF DESCRIPTION OF THE DRAWINGS

FIG. 1 is a perspective view of a matrix band device in use according to an exemplary embodiment of the present invention;

FIG. 2 is a perspective view of the matrix band device of FIG. 1;

FIG. 3 is a perspective view of a matrix band device according to a further exemplary embodiment of the present invention;

FIG. 4 is a perspective view of a matrix band device according to still another exemplary embodiment of the present invention;

FIG. 5 is a perspective view of a matrix band device in use according to another exemplary embodiment of the present invention;

FIG. 6 is a perspective view of the parts of the matrix band device of FIG. 5; and

FIG. 7 is a cross-sectional view taken along line 3-3 of FIG. 6.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a dental matrix band device that may be applied in a single step without the need for additional instruments for its application. The matrix band device may include a conventional matrix band, such as a Tofflemier™ band and a wire attached to the band. The band may be used to separate adjacent teeth, while the wire keeps the band in place until the procedure is completed. At the completion of the procedure, the band and wire are easily removed from the patient.

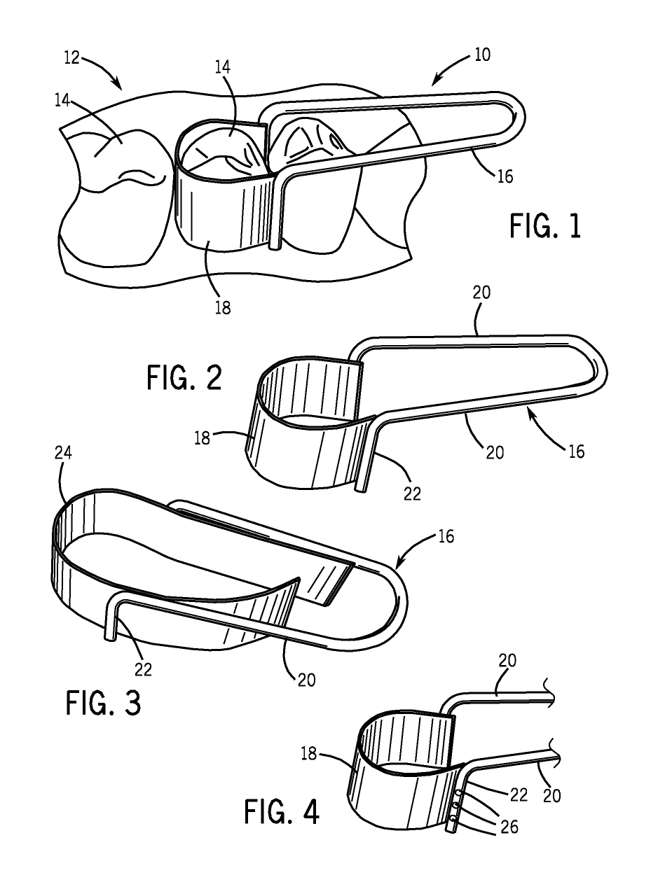

Referring to FIGS. 1 and 2, a matrix band device 32 may include a wire 34 having legs 38 bent to formed angled portions 40. The angled portions 40 may be attached to a band 36, such as a Tofflemier™ band. The band 36 may fit around a tooth 14 in a patient's mouth 12. The wire 34 may be resiliently deformed to hold the band 36 on the tooth 14. The angled portions 40 of the wire 34 may be disposed, in use, on the lingual and buccal sides of the tooth 14.

The wire 34 may be attached to the band 36 by conventional means, such as by glue, solder, welding or the like. As shown in FIG. 4, the angled portions 40 may be welded on the band 36 by a weld 44.

Referring to FIG. 3, a matrix band device may be formed similar to the matrix band device of FIGS. 1 and 2, however, in this embodiment, the matrix band 42 may extend beyond the point of attachment of the wire 34. This extension in the matrix band 42 may allow it to extend around the side of the tooth that is not banded in the embodiment of FIGS. 1 and 2, thereby effectively resulting in the matrix band 42 extending about the entire tooth.

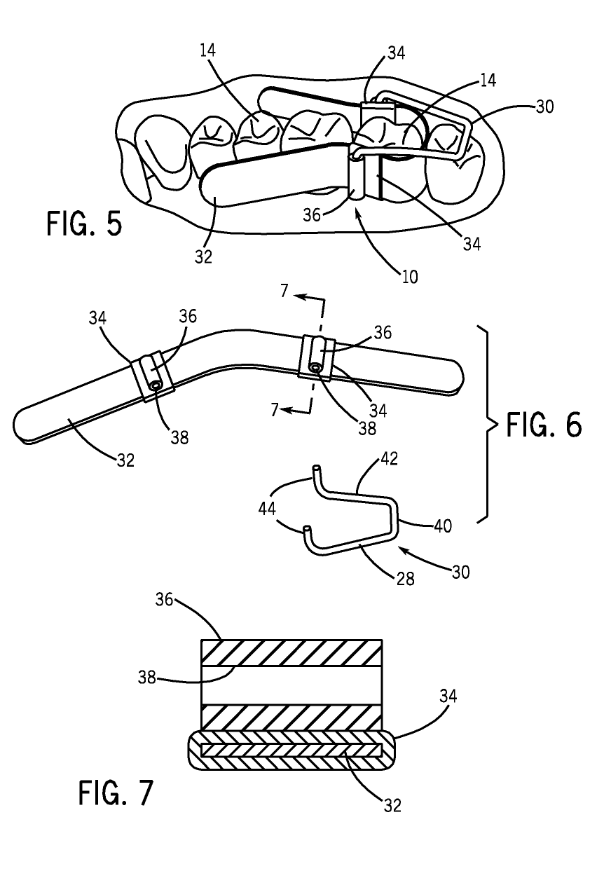

Referring to FIGS. 5 through 7, a matrix band device 10 may include a matrix band 18, having first and second sliding members 20 disposed to slide along the matrix band 18. The sliding members 20 may include tubes 22 attached thereto. The tubes 22 may be substantially perpendicular to the length-wise axis of the matrix band 18. A wire 16 may have a mid section 26 connecting two legs 28. Angled ends 30 may be attached to each of the legs 28. The angled ends 30 may be spaced apart from each other a predetermined distance, this distance being less than a width of a tooth onto which the matrix band device is adapted to be applied when in use. This distance may be increased by resiliently deforming the wire 16 to separate the angled ends 30. The angled ends 30 may fit into holes 24 in the tubes 22. The wire 16 may be an orthodontic or similar type wire.

In use, as shown in FIG. 5, the matrix band device 10 may fit around a tooth 14 inside the mouth of the patient. The wire 16 may be resiliently deformed to provide a force between the sliding metal members 20 and the tooth 14. This force may hold the matrix band device 10 in place during a restoration. Once the procedure is complete, the matrix band device 10 may be easily removed. There is no need for additional tools (such as a retainer or retaining ring) to be used to place and hold the matrix band device 10.

The matrix band devices described above may be used to isolate a tooth for a restoration. The dental professional may be able to simply apply the matrix band in a single step and begin the restoration. The matrix band devices of the present invention may be useful in, for example, mesio-occlusal (MO), distal-occlusal (DO) and mesio-occluso-distal (MOD) restorations. In addition, the matrix band devices of the present invention may be placed back to back, permitting a DO and MO restoration to be completed at the same time. Once the restoration is complete, the matrix band device may be easily removed, autoclaved and reused.

It should be understood, of course, that the foregoing relates to exemplary embodiments of the invention and that modifications may be made without departing from the spirit and scope of the invention as set forth in the following claims.

1. A matrix band device comprising:
a matrix band comprising an elongate metal strip having two opposite ends;
a wire having two ends and a bend in a central portion thereof to form two legs, each leg being bent at its end to form an angled portion, wherein each angled portion is attached to an end of the matrix band preforming the matrix band in a curved configuration.

2. The matrix band device of claim 1, said matrix band comprising tubes positioned on the ends thereof, wherein the angled portions of the wire fit into the tubes positioned on the matrix band.

3. (canceled)

4. The matrix band device of claim 1, wherein the angled portions of the wire are permanently affixed to the matrix band.

5. The matrix band device of claim 1, wherein the angled portions are spaced apart from each other a distance, the distance being less than a width of a tooth onto which the matrix band device is adapted to be applied when in use.

6. The matrix band device of claim 5, wherein the angled portions resiliently deform to increase the distance therebetween.

7. The matrix band device of claim 4, wherein ends of the matrix band are affixed to the angled portions of the wire.

8. The matrix band device of claim 4, wherein ends of the matrix band extend beyond the point of attachment of the angled portions of the wire to the matrix band.

9. A method for isolating a tooth for a dental restoration, comprising:
resiliently deforming angled ends of a wire, the angled ends being attached to a matrix band;
sliding the matrix band about an occlusal surface of the tooth while the angled ends of the wire are positioned at lingual and buccal sides of the tooth; and
retaining the matrix band in place by allowing a resilient force of the angled ends of the wire to press against the lingual and buccal sides of the tooth.

10. The method of claim 9, further comprising removing the matrix band and wire upon completion of the dental restoration.
